(19) United States
(12) Patent Application Publication
(10) Pub. No.: US 2024/0347945 A1
(43) Pub. Date: Oct. 17, 2024

(54) ELECTRONIC APPARATUS IMPROVED IN DURABILITY OF SOLDER JOINT

(71) Applicant: CANON KABUSHIKI KAISHA, Tokyo (JP)

(72) Inventor: TAKAZUMI SEO, Tokyo (JP)

(21) Appl. No.: 18/626,429

(22) Filed: Apr. 4, 2024

(30) Foreign Application Priority Data
Apr. 11, 2023 (JP) 2023-064316

(51) Int. Cl. H01R 12/77; H01R 12/81; H01R 13/512; H01R 13/516; H01R 24/78; H01R 107/00; H04N 5/765; H04N 21/4363

(52) U.S. Cl. CPC H01R 12/772; H01R 12/81; H01R 13/512; H01R 13/516; H01R 24/78; H04N 5/765; H04N 21/43635; H01R 2107/00; H01R 2201/18

(57) ABSTRACT

An image capturing apparatus includes an HDMI flexible circuit having a mounting surface, an HDMI connector mounted on the mounting surface of the HDMI flexible circuit, a plug being capable of being inserted therein and removed therefrom, a main base having a mounting portion substantially parallel to the mounting surface, and a reinforcing member that includes part covering the HDMI connector from an opposite side to the mounting portion in a direction orthogonal to the mounting surface and is fixed to the main base. The HDMI connector and the HDMI flexible circuit can move in the direction orthogonal to the mounting surface between the main base and the reinforcing member. In the direction orthogonal to the mounting surface, a minimum clearance between the reinforcing member and the HDMI connector is smaller than a minimum clearance between the reinforcing member and the HDMI flexible circuit.

### BACKGROUND OF THE INVENTION

### Field of the Invention

The present invention relates to an electronic apparatus, such as an image capturing apparatus, which is improved in the durability of a solder joint.

### Description of the Related Art

An electronic apparatus, such as a digital camera, is known which is configured such that a circuit board is arranged therein with a connector mounted thereon for removably inserting a plug therein, and a plug insertion port of the connector is exposed from a hole formed in an exterior member. The electronic apparatus has a possibility that a force is applied to the connector due to prying of a plug when or after inserting the plug, whereby an excess load is applied to a solder joint between the connector and the circuit board, causing degradation of connection of the solder joint. To prevent this, Japanese Laid-Open Patent Publication (Kokai) No. 2011-165345 proposes an image capturing apparatus that resiliently urges a top surface of the connector by a reinforcing member, to thereby restrict movement of a connector, which is caused by a prying force.

The technique disclosed in Japanese Laid-Open Patent Publication (Kokai) No. 2011-165345 is capable of reducing the amount of movement of the connector, which is caused by the prying force, by using the reinforcing member. However, the circuit board is fixed to a chassis with screws, and hence this causes a problem that the connector moves in a direction in which the connector is pulled off from the circuit board, so that a load is applied to the solder joint of the connector.

### SUMMARY OF THE INVENTION

The present invention provides an electronic apparatus improved in the durability of a solder joint between a connector and a circuit board.

The present invention provides an electronic apparatus including a circuit board having a mounting surface, a connector mounted on the mounting surface of the circuit board, a plug being capable of being inserted into and removed from the connector, a chassis having a mounting portion substantially parallel to the mounting surface, and a reinforcing member that includes a portion covering the connector from an opposite side to the mounting portion in a direction orthogonal to the mounting surface and is fixed to the chassis, wherein the connector and the circuit board can move in the direction orthogonal to the mounting surface between the chassis and the reinforcing member, and wherein in the direction orthogonal to the mounting surface, a minimum clearance between the reinforcing member and the connector is smaller than a minimum clearance between the reinforcing member and the circuit board.

According to the present invention, it is possible to improve the durability of the solder joint between the connector and the circuit board.

Further features of the present invention will become apparent from the following description of exemplary embodiments (with reference to the attached drawings).

### BRIEF DESCRIPTION OF THE DRAWINGS

FIGS. 1A to 1C are perspective views and a bottom view of an electronic apparatus.

FIGS. 2A and 2B are rear perspective views of a camera, respectively.

FIGS. 3A to 3C are a front exploded perspective view showing components of an exterior unit, a rear exploded perspective view showing components of a front cover unit, and a rear view showing the front cover unit and a stand fixed thereto, respectively.

FIGS. 4A to 4C are a front exploded perspective view of an internal structure unit, a front exploded perspective view of a main base unit, and a partial rear perspective view of a main base, respectively.

FIGS. 5A to 5E are a front perspective view and a rear perspective view of an HDMI (registered trademark) connector and so forth, a front perspective view and a rear perspective view of a reinforcing member, and a perspective view illustrating how the HDMI connector and the reinforcing member are assembled to the main base, respectively.

FIGS. 6A to 6D are a right side view, a front view, and cross-sectional views, taken along line A-A and line B-B, of an upper portion of the camera, respectively.

FIG. 7 is a partial cross-sectional view of a variation of the camera.

FIGS. 8A and 8B are a view of the HDMI connector and so forth, as viewed from a +Z side, and a view of the reinforcing member and so forth, as viewed from the +Z side.

FIG. 9 is a cross-sectional view taken along line C-C of FIG. 8B.

### DESCRIPTION OF THE EMBODIMENTS

The present invention will now be described in detail below with reference to the accompanying drawings showing embodiments thereof.

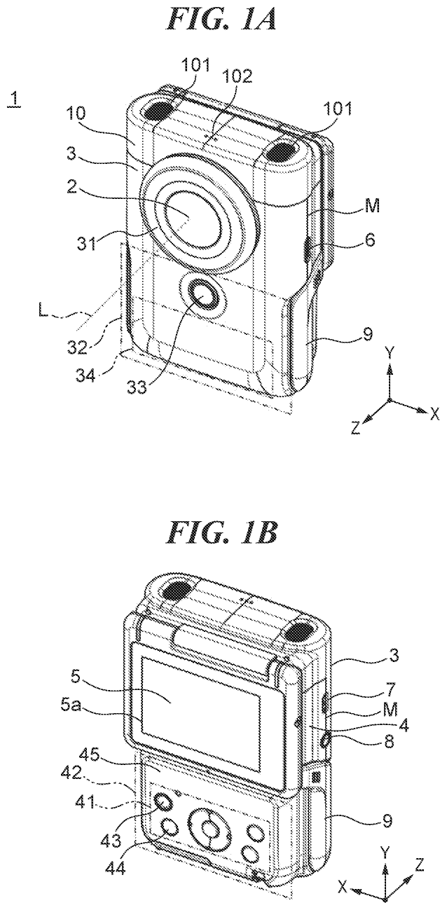

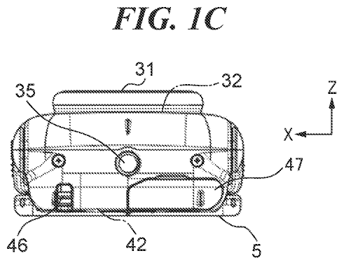

FIGS. 1A and 1B are perspective views of an electronic apparatus according to an embodiment of the present invention. In the present embodiment, as the electronic apparatus, a camera 1, which is an image capturing apparatus, will be described by way of example. An optical axis of a lens barrel unit 2 included in the camera 1 is referred to as an optical axis L.

Hereafter, directions of each component are defined based on X, Y, and Z coordinate axes. Here, an object side in a direction parallel to the optical axis L is referred to as a front side for convenience sake. Therefore, a +Z direction parallel to the optical axis L is defined as a direction toward the front side and a +Y direction is defined as a direction toward an upper side. A +X direction is defined as a direction toward a left side, as viewed from a photographer (right side as viewed from the object side). Therefore, FIGS. 1A and 1B are the front perspective view and the rear perspective view of the camera 1, respectively. FIG. 1C is a bottom view of the camera 1.

The lens barrel unit 2 including a photographing optical system is arranged on a front side of the camera 1. The lens barrel unit 2 is a fixed-type single-focus lens which is a known lens barrel and has a shutter mechanism, a focus mechanism, and so forth, arranged inside thereof. Even when the power is switched to an on-state (in-use state) by a user, the lens barrel unit 2 is not extended.

The appearance on the front side of the camera 1 is formed by a front cover 3. A front ring 31 protruding from the front cover 3 toward the +Z side is provided on an outer periphery of the lens barrel unit 2. A front grip area 32 used by a user to hold the camera 1 is provided on the −Y side of the front ring 31. Since the front ring 31 protrudes with respect to the front grip area 32, the user can easily hold the front grip area 32. Therefore, the protruding front ring 31 becomes a mark when the user holds the front grip area 32, and it is made difficult for the hand holding the front grip area 32 to enter a photographing field angle of the lens barrel unit 2.

A start/stop button 33 is disposed at a location toward the +Y side in the front grip area 32. When the start/stop button 33 is pressed, photographing is started, and when the start/stop button 33 is pressed again, the photographing is terminated. An area on the −Y side of the start/stop button 33 in the front grip area 32 is a front finger-placing area 34 for placing fingers when the user holds the front grip area 32.

The appearance of a rear side of the camera 1 is formed by a rear cover 4. A display section 5 and a rear operation member 41 are provided on the rear side of the camera 1. The display section 5 is comprised of a TFT-type LCD and includes a touch panel 5a which can detect a user's touch operation. When the camera 1 is set to a still image mode or a moving image mode in a state in which the camera 1 is in the power-on state, an object image (through image) captured by an image sensor are displayed on the display section 5 based on image signals.

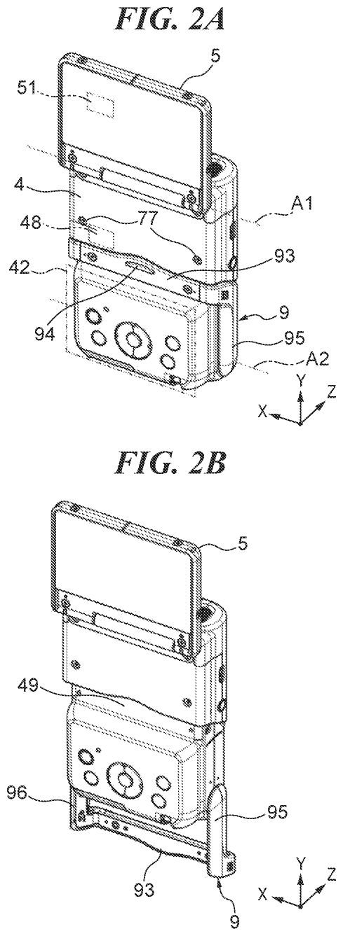

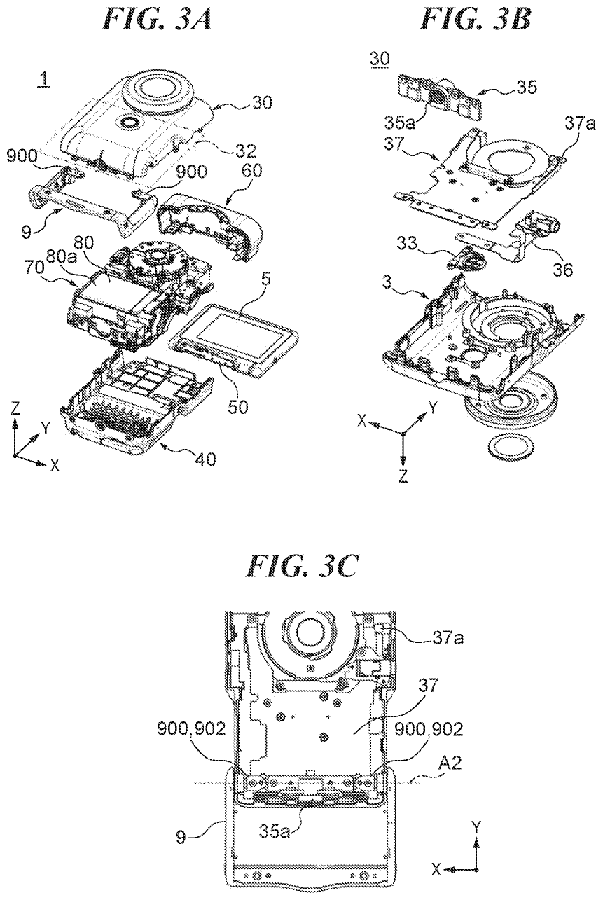

Further, the display section 5 is connected to a camera body by a display section hinge 50 (see FIG. 3A). The display section hinge 50 has a display section rotational axis A1 (see FIG. 2A) which is substantially parallel to the camera body in the X direction, and the display section 5 can be rotated about the display section rotational axis A1 through approximately 180 degrees. With this, when taking a selfie, the user can perform photographing while confirming the composition of an image on the display section 5.

A rear grip area 42 used by a user to hold the camera 1 is provided on the −Y side of the display section 5 at a location recessed from the display section 5 toward the −Z side. The display section 5 protrudes with respect to the rear grip area 42, which makes it easier for the user to hold the rear grip area 42. Therefore, the protruding display section 5 becomes a mark when the user holds the rear grip area 42, and it is made difficult for the hand holding the rear grip area 42 to enter the area of the touch panel 5a of the display section 5.

The rear operation member 41 is arranged on the −Y side in the rear grip area 42. The rear operation member 41 includes a power button 43 for switching on/off the power of the camera 1 and a reproduction button 44 for instructing reproduction of a recorded photographed image. An area on the +Y side of the rear operation member 41 in the rear grip area 42 is a rear finger-placing area 45 for placing a thumb of the user when the user holds the rear grip area 42.

In the Y direction, the start/stop button 33 is located in the range of the rear finger-placing area 45 and the rear operation member 41 is located in the range of the front finger-placing area 34. With this arrangement of these areas, the user can sandwich and hold the operation member and the finger-placing area, which are associated with each other, and perform a reliable pressing operation.

The appearance of the side surfaces of the camera 1 is formed by the front cover 3 and the rear cover 4. jacks (terminals), such as a USB connector 6, a high-definition multimedia interface (HDMI; registered trademark) connector 7, and a microphone input terminal 8, are arranged in a joint position M in the Z direction between the front cover 3 and the rear cover 4. Each jack is disposed on the +Y side of the front grip area 32 and the rear grip area 42. This arrangement prevents, when the user holds the camera 1 or places the camera 1, for example, on a desk, a cable inserted into each jack from becoming an obstacle to operation of the user, thereby providing high user-friendliness.

A stand 9 is provided in the lower half part of the camera 1, and the appearance of the side surfaces of the camera 1 is formed by stand side covers 95 and 96 (see FIG. 2B) of the stand 9. In an accommodated state of the stand 9, the stand side covers 95 and 96 form substantially the same shape as the side surface shapes of the front cover 3 and the rear cover 4, and hence does not cause a sense of strangeness or hinder the user from holding the camera 1.

The stand 9 is connected to the camera body by stand hinges 900 (see FIG. 3A). The stand hinges 900 have a stand rotational axis A2 (see FIG. 2A) substantially parallel to the X direction. The stand hinges 900 can be rotated about the stand hinge rotational axis A2. By using the stand 9, the user can tilt the camera 1 and perform photographing by placing the camera 1 in a variety of postures.

The appearance of the upper portion of the camera 1 is formed by a top cover 10. The upper surface of the top cover 10 is formed with microphone holes 101 for a microphone, symmetrically arranged with respect to the optical axis of the lens barrel unit 2, and speaker holes 102 for a speaker, for reproducing sound of operations and sound of a photographed moving image. Since the microphone holes 101 are located in the top surface of the camera 1, it is possible to reduce a difference in sound collection performance between received sounds arriving from the front side and the rear side of the camera 1 in the Z direction.

On the bottom surface of the camera 1, there are arranged a tripod mount 35 for mounting an accessory, such as a tripod, a strap attachment portion 46 for inserting a strap, and a media cover 47 (see FIG. 1C). The media cover 47 is attached to the camera body such that the media cover 47 can be opened and closed, and a recording medium (not shown) as an external memory can be attached and removed when the media cover 47 is open.

The operations of the display section 5 and the stand 9 will be described with reference to FIGS. 2A and 2B. FIG. 2A is a rear perspective view of the camera 1 in a state in which the display section 5 is opened and the stand 9 is accommodated. FIG. 2B is a rear perspective view of the camera 1 in a state in which the display section 5 is opened and the stand 9 is in a standing state.

The display section 5 can be shifted to the accommodated state shown in FIGS. 1A and 1B and the opened state shown in FIGS. 2A and 2B by rotating the display section 5 about the display section rotational axis A1. When the display section 5 is rotated through approximately 180 degrees from the accommodated state, the display section 5 is shifted to the opened state. The stand 9 can be shifted to the accommodated state shown in FIGS. 1A, 1B, and 2A and the standing state shown in FIG. 2B by rotating the stand 9 about the stand rotational axis A2. When the stand 9 is rotated through approximately 180 degrees from the accommodated state, the stand 9 is shifted to the standing state.

A magnet 51 is disposed inside the display section 5, and a yoke 48, which is a magnetic body, is disposed inside the rear cover 4. When the display section 5 is shifted from the opened state to the accommodated state, the display section 5 receives a mechanical suction force applied by the display section hinge 50 (see FIG. 3A) and a magnetic absorption force applied by the magnet 51 and the yoke 48. With these forces, the display section 5 is automatically shifted from a predetermined open angle to the accommodated state.

The stand 9 is comprised of the stand side covers 95 and 96 arranged on opposite sides of the stand hinges 900 in the X direction, and a stand intermediate cover 93 connecting the stand side covers 95 and 96, and these components rotate in unison. The stand intermediate cover 93 is provided with a cushion member 94 (see FIG. 2A) for reducing collision sound generated when the display section 5 is moved to the accommodated state.

The rear cover 4 is formed with a stand accommodating portion 49 for accommodating the stand intermediate cover 93 in an area hidden by the display section 5 and on the +Y side of the rear grip area 42. The display section rotational axis A1 and the stand rotational axis A2 are both substantially parallel to the X direction and are arranged in the vicinity of the opposite ends of the camera 1 in the Y direction. When the stand 9 is in the accommodated state, the stand intermediate cover 93 is positioned substantially in the center between the display section rotational axis A1 and the stand rotational axis A2 in the Y direction.

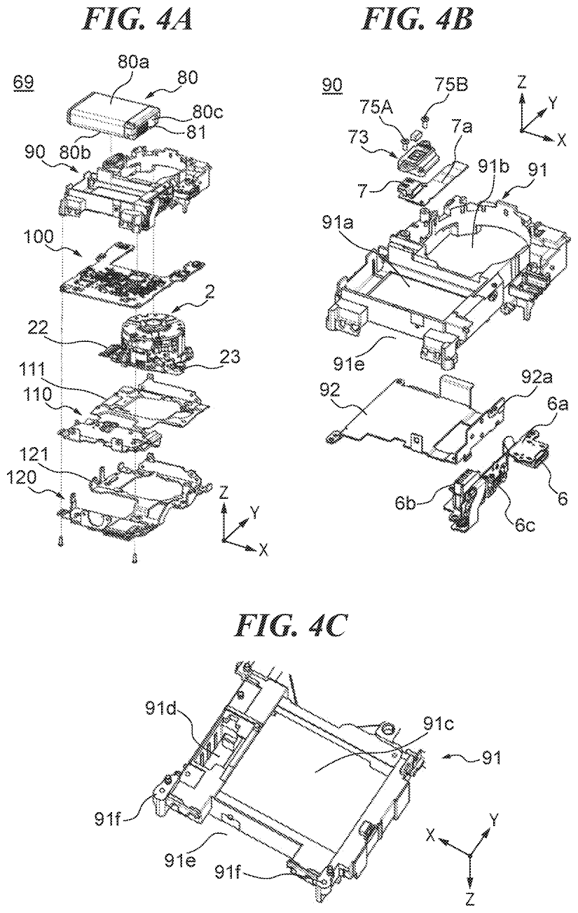

Components of exterior units of the camera 1 will be described with reference to FIGS. 3A to 3C. FIG. 3A is a front exploded perspective view showing the components of the exterior units of the camera 1. Each exterior unit is assembled to an internal structure unit 69. The exterior units include a front cover unit 30, a rear cover unit 40, a top cover unit 60, the display section 5, and the stand 9. In the internal structure unit 69, a battery 80 is accommodated and held. The battery 80 has a substantially rectangular parallelepiped shape, and has a first surface 80a and a second surface 80b (see FIG. 4A), both of which are substantially orthogonal to the Z direction. A thickness direction of the battery 80 is substantially parallel to the Z direction. When the front cover unit 30 is removed, the first surface 80a of the battery 80 is exposed, which enables the battery 80 to be removed.

FIG. 3B is a rear exploded perspective view showing the components of the front cover unit 30. Inside the front grip area 32 (see FIG. 1B) on the front cover 3, there are arranged a front flexible printed circuit (FPC) 36, a front heat sink 37, and the tripod mount 35. On the front FPC 36, a switch of the start/stop button 33 is mounted. The front heat sink 37 holds the front FPC 36.

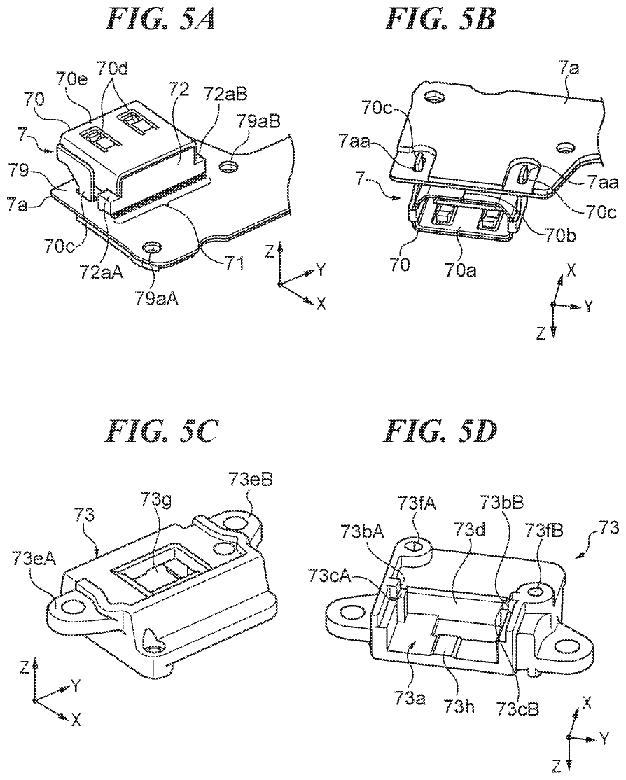

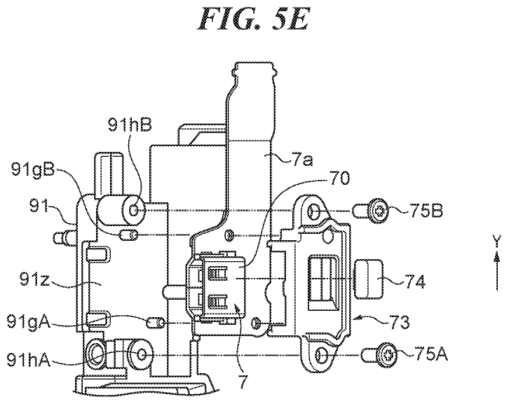

The front heat sink 37 is manufactured by pressing a sheet metal (such as aluminum or copper) having high thermal conductivity and high strength, and is fastened to the front cover 3 from inside with screws in a state in which the front FPC 36 is assembled to the front heat sink 37. The front heat sink 37 is arranged such that it covers the first surface 80a of the battery 80. The sheet metal member can secure the rigidity even though the sheet metal is thinner than a resin member. Since the front heat sink 37 is formed by the sheet metal member, it is possible to reduce the size of the camera 1 in the thickness direction (Z direction) while securing a shape for restricting the position of the battery 80 in the Z direction. Further, the front heat sink 37 has a connection portion 37a extended in the Z direction, which is brought into contact with a gasket 74 (see FIG. 5E) to secure conduction.

The tripod mount 35 has a tripod screw portion 35a. The tripod mount 35 is fastened to the front cover 3 from inside with screws in a state in which the front heat sink 37 is sandwiched between the tripod mount 35 and the front cover 3. With this, conduction between the tripod mount 35 and the front heat sink 37 is secured. Note that the tripod mount 35 can be made of a sheet metal or die cast insofar as it is possible to secure the strength and the necessary shape thereof.

FIG. 3C is a rear view showing a state in which the stand 9 is fixed to the front cover unit 30. Fixing plates 902 of the respective stand hinges 900 are arranged in areas on opposite sides of the tripod screw portion 35a in the X direction. Each fixing plate 902 is fastened to the front cover 3 from inside with screws in a state in which the front heat sink 37 is sandwiched between each fixing plate 902 and the front cover 3. With this, conduction between the stand hinges 900 and the front heat sink 37 is secured. That is, the stand hinges 900 secures conduction with the tripod mount 35 via the front heat sink 37. Note that although in the present embodiment, the stand hinges 900 are fixed to the front cover 3 with the screws, the stand hinges 900 can be directly fixed to the tripod mount 35 with screws.

The components of the internal structure unit 69 will be described with reference to FIGS. 4A to 4C. FIG. 4A is a front exploded perspective view of the internal structure unit 69. The internal structure unit 69 is formed by assembling the lens barrel unit 2, the battery 80, a main circuit board 100, a rear heat sink unit 110, and a main chassis unit 120 to a main base unit 90.

FIG. 4B is a front exploded perspective view of the main base unit 90. The main base unit 90 includes a main base 91 (chassis) as a component serving a base. The main base 91 is formed of a resin material. The main base 91 is formed with a battery chamber 91a for accommodating and holding the battery 80 and a barrel chamber 91b for accommodating and holding the lens barrel unit 2. The battery chamber 91a is arranged within a range overlapping the front grip area 32 (see FIG. 1A), as viewed from the Z direction.

FIG. 4C is a partial rear perspective view of the main base 91. A-Z side surface of the main base 91 is formed with a cutout shape 91c. An intermediate heat sink 92 (see FIG. 4B) is arranged such that it covers the cutout shape 91c. The intermediate heat sink 92 is formed by a sheet metal member that is thin but has high rigidity, which makes it possible to reduce the size of the battery chamber 91a in the thickness direction (Z direction) while securing the shape that restricts the position of the battery 80 in the Z direction.

As shown in FIG. 4B, on the outer periphery of the barrel chamber 91b, there are arranged the USB connector 6 that is connected to an external apparatus to transfer data and supply electric power and the HDMI connector 7 that transmits video signals to an external display device. A plug (not shown) can be inserted into and removed from the HDMI connector 7. The HDMI connector 7 is mounted on an HDMI flexible circuit 7a and is connected to the main circuit board 100. A reinforcing member 73, described hereinafter, is assembled to the main base 91.

The USB connector 6 is mounted on a USB flexible circuit 6a and is connected to the main circuit board 100. The USB flexible circuit 6a has a battery connector 6b electrically connected to the battery 80 and a power supply circuit area 6c on which a device related to a power supply circuit, such as a charge IC, is mounted.

A third surface 80c (see FIG. 4A) of the battery 80 is provided with a contact portion 81 connected to the battery connector 6b. The third surface 80c is substantially orthogonal to the first surface 80a and the second surface 80b, and is substantially orthogonal to the X direction. An end portion of the intermediate heat sink 92 on the +X side is formed with a third extended portion 92a. The third extended portion 92a is substantially parallel to the third surface 80c of the battery 80.

The power supply circuit area 6c of the USB flexible circuit 6a is fixed to the third extended portion 92a so as to be grounded (electrically connected or earthed) thereto, and is configured to be capable of transmitting heat generated in the power supply circuit to the intermediate heat sink 92.

The main base 91 is formed with a battery connector space 91d for accommodating and holding the battery connector 6b (see FIG. 4C). The battery connector space 91d is arranged on a surface opposed to the third surface 80c of the battery 80.

The main base 91 is formed with a tripod chamber 91e for accommodating the tripod mount 35, on the −Y side of the battery chamber 91a. Screw seats 91f are formed at opposite ends of the main base 91 in the X direction across the tripod chamber 91e (see FIG. 4C). To the screw seats 91f, the main circuit board 100, a rear heat sink 111, and a main chassis 121 (see FIG. 4A) are fixed with screws. Each screw seat 91f is disposed at a location overlapping a projected shadow of an associated one of the fixing plates 902 (see FIG. 3C) of the stand 9, as viewed from the Z direction. However, the screw seats 91f and the fixing plates 902 are in respective positions different in the Z direction, and hence the screw seats 91f can be disposed.

As shown in FIG. 4A, the main circuit board 100 includes connectors for electrically connecting a CPU and the flexible circuits. The main circuit board 100 is fixed to the main base 91. The main circuit board 100 is disposed such that it is substantially orthogonal to the optical axis L and is formed into a substantially U-shape as viewed from the optical axis direction.

The lens barrel unit 2 includes an image sensor (not shown) that generates image data by photoelectrically converting an optical image of an object, which is formed through the plurality of photographic lenses forming the photographing optical system. This image sensor is implemented, for example, by a CCD or a CMOS sensor and is mounted on a sensor FPC 22.

Inside the lens barrel unit 2, actuators (not shown) for the shutter mechanism, the focus mechanism, and so forth, are arranged, and the actuators are mounted on an actuator FPC 23. The rear heat sink unit 110 includes the rear heat sink 111, a wireless communication circuit board (not shown), and a wireless FPC (not shown). The rear heat sink 111 is manufactured by pressing a sheet metal (such as aluminum or copper) having high thermal conductivity and high strength. The wireless communication circuit board has a function of wireless communication with the outside. The wireless FPC communicably connects between the wireless communication circuit board and the main circuit board 100.

The main chassis unit 120 has the main chassis 121 and a rear operation circuit board (not shown). The main chassis 121 is a ground member which is manufactured by pressing a sheet metal into a structure body of the camera 1 and serves as a ground (GND). On the rear operation circuit board, switches of the rear operation member 41 (see FIG. 1B) are mounted.

The lens barrel unit 2 is assembled to the barrel chamber 91b (see FIG. 4B) of the main base 91 after the main circuit board 100 is assembled, and the sensor FPC 22 and the actuator FPC 23 are connected to the connectors of the main circuit board 100. After that, the rear heat sink unit 110 and the main chassis unit 120 are assembled. These units are fastened to the screw seats 91f of the main base 91 with screws in a state in which the main circuit board 100 is sandwiched between these units and the main base 91. With this, the main chassis 121 as the mechanical main GND and the main circuit board 100 as the electrical main GND are grounded.

Further, the rear heat sink unit 110 and the main chassis unit 120 are also fastened to the main base 91 with a plurality of screws around the barrel chamber 91b and are further fastened to the tripod mount 35 on the bottom side with a plurality of screws. The fastening described above ensures conduction between the main chassis 121 and the tripod mount 35, and ensures conduction between the main chassis 121 and the front heat sink 37 via the tripod mount 35.

The lens barrel unit 2 is sandwiched and held between the main base 91 and the main chassis 121 via a resilient member (not shown). This makes the microphone disposed in the camera 1 difficult to be affected by vibration caused by the actuator or the like in the lens barrel unit 2.

The configuration for mounting the HDMI connector 7 and the reinforcing member 73 will be described with reference to FIGS. 5A to 5E. FIGS. 5A and 5B are a front perspective view and a rear perspective view of the HDMI connector 7 and so forth. FIGS. 5C and 5D are a front perspective view and a rear perspective view of the reinforcing member 73. FIG. 5E is a perspective view illustrating how the HDMI connector 7 and the reinforcing member 73 are assembled to the main base 91.

Further, as shown in FIGS. 5A and 5B, the HDMI connector 7 includes a contact connector part 72 (resin part) and a shell 70. The shell 70 is a member which is made of metal and functions as a shield for blocking the influence of noise and the like, which are received from a surrounding environment. When manufacturing the shell 70, an opening 70a for inserting a plug (not shown) is formed by bending a plate-shaped metal material into a loop shape. That is, the metal material is bent such that end surfaces of opposite ends of the metal material bent into the loop shape are opposed and brought into contact with each other. A portion where the opposed end surfaces are brought into contact with each other forms a joint 70b, and the joint 70b is disposed on a side toward the HDMI flexible circuit 7a (−Z side) in the Z direction.

A pair of fixing portions 70c to be fixed to the HDMI flexible circuit 7a are extended from the shell 70. That is, the pair of fixing portions 70c are formed by bending the metal material in a plug inserting direction (+X direction) at the opposite ends of the opening 70a. Part of each fixing portion 70c, extended toward the −Z side, is inserted through an associated through hole 7aa in the HDMI flexible circuit 7a and is through-hole mounted. With this, the fixing portions 70c are grounded to the GND terminal of the HDMI flexible circuit 7a.

The contact connector part 72 is a resin part having a plurality of contact terminals 71 insert-molded therein. The plurality of contact terminals 71 are surface-mounted and electrically connected to signal terminals of the HDMI flexible circuit 7a, respectively. In the surface-mounting mentioned here, differently from the through-hole mounting, the plurality of contact terminals 71 are soldered only to a mounting surface 79 of the HDMI flexible circuit 7a. Since a hole, such as the through hole 7aa, is not required, the plurality of contact terminals 71 can be arranged at a narrow pitch, but are not strong enough. When manufacturing the contact connector part 72, heat-resistant synthetic resin having electrical insulation properties, such as liquid crystal polymer or nylon, is poured into a mold in a state in which the plurality of contact terminals 71 are arranged in the mold. With this, the contact connector part 72 in which the plurality of contact terminals 71 are held by the heat-resistant synthetic resin is formed.

In general, there has been proposed a connector provided with portions, which correspond to the pair of fixing portions 70c, at a plurality of locations, as a countermeasure against prying caused after inserting a plug. However, there is a possibility that the size of the connector is increased in the plug inserting direction (X direction) or in the pitch direction (arrangement direction: Y direction) of the plurality of contact terminals 71, which can affect the size of the electronic apparatus. To prevent this, in the present embodiment, urging portions 70d which function as a retainer of a plug inserted into the HDMI connector 7 are provided in a +Z side surface of the shell 70.

The contact connector part 72 closes the rear part of the opening 70a of the shell 70. The contact connector part 72 has flange portions 72aA and 72aB (hereafter sometimes collectively indicated by 72a) protruding from opposite sides of the shell 70 at respective locations rearward of the fixing portions 70c. By fitting the shell 70 on the contact connector part 72 from the −X side, the HDMI connector 7 is completed.

The HDMI flexible circuit 7a is formed with positioning holes 79a (79aA and 79aB) for positioning the HDMI flexible circuit 7a with respect to the main base 91. By connecting the HDMI flexible circuit 7a to the main circuit board 100 (see FIG. 4A), video signals can be output to an external display device attached to the HDMI connector 7.

The reinforcing member 73 shown in FIGS. 5C and 5D is a member for suppressing damage to the solder joint between the HDMI connector 7 and the HDMI flexible circuit 7a, which is caused by a prying force after inserting a plug. The reinforcing member 73 is formed of a resin material and includes a shell accommodating portion 73a. The shell accommodating portion 73a covers opposite side surfaces in the Y direction and a +Z-side surface 70e (see FIG. 5A) of the HDMI connector 7. The shell accommodating portion 73a is formed into a recessed shape by a pair of engaging portions 73bA and 73bB (hereafter sometimes collectively indicated by 73b), a pair of contact surfaces 73cA and 73cB (hereafter sometimes collectively indicated by 73c), and a contact surface 73d.

The pair of engaging portions 73b restrict movement of the HDMI connector 7 in the pitch direction (Y direction) of the plurality of contact terminals 71. The pair of contact surfaces 73c restrict movement of the HDMI connector 7 in a direction (Z direction) orthogonal to the mounting surface 79 of the HDMI flexible circuit 7a. The contact surface 73d restricts movement of the HDMI connector 7 in the plug inserting direction (X direction).

Opposite side portions of the reinforcing member 73 in the Y direction are provided with screw fastening portions 73eA and 73eB (hereafter sometimes collectively indicated by 73e), respectively. A-Z side surface of the reinforcing member 73 is formed with positioning holes 73fA and 73fB (hereafter sometimes collectively indicated by 73f) for positioning the reinforcing member 73 with respect to the main base 91. A +Z side surface of the shell accommodating portion 73a is formed with an opening 73g for a gasket. The opening 73g extends through the reinforcing member 73 in a direction (Z direction) orthogonal to the mounting surface 79. The shell accommodating portion 73a is formed with a protruding portion 73h (see FIG. 5D) protruding toward the +X side.

As shown in FIG. 5E, the main base 91 includes a mounting portion 91z. The mounting portion 91z has a surface substantially parallel to the mounting surface 79. From the mounting portion 91z, boss seats 91hA and 91hB (hereafter sometimes collectively indicated by 91h) and positioning bosses 91gA and 91gB (hereafter sometimes collectively indicated by 91g) are formed to protrude toward the +Z direction. The positioning bosses 91gA and 91gB are inserted through the positioning holes 79aA and 79aB (see FIG. 5A) of the HDMI flexible circuit 7a and the positioning holes 73fA and 73fB of the reinforcing member 73 (see FIG. 5D), respectively. With this, the relative positions of the HDMI connector 7, the HDMI flexible circuit 7a, and the reinforcing member 73 to the main base 91 in the surface direction (X-Y direction) of the mounting surface 79 are determined.

For this positioning, the reinforcing member 73 is directly fixed to the boss seats 91hA and 91hB of the main base 91 via the screw fastening portions 73eA and 73eB with screws 75A and 75B (hereafter sometimes collectively indicated by 75) without sandwiching the HDMI flexible circuit 7a. Therefore, the reinforcing member 73 is fixed to the main base 91 at opposite side positions (positions of the screw fastening portions 73e) of the HDMI connector 7 in the Y direction.

The reinforcing member 73 includes portions for covering the HDMI connector 7 and the HDMI flexible circuit 7a from an opposite side (+Z side) to the mounting portion 91z in a direction orthogonal to the mounting surface 79. For example, the pair of contact surfaces 73c and the protruding portion 73h correspond to these portions.

The HDMI connector 7 and the HDMI flexible circuit 7a are not directly fixed to the main base 91 with screws or the like. Therefore, the HDMI connector 7 and the HDMI flexible circuit 7a can move in unison in the direction orthogonal to the mounting surface 79 (Z direction) and the Y direction in a range restricted by the main base 91 and the reinforcing member 73. Note that the position of the HDMI connector 7 in the Z direction and the Y direction is restricted in a space formed by the main base 91 and the reinforcing member 73 with some clearance.

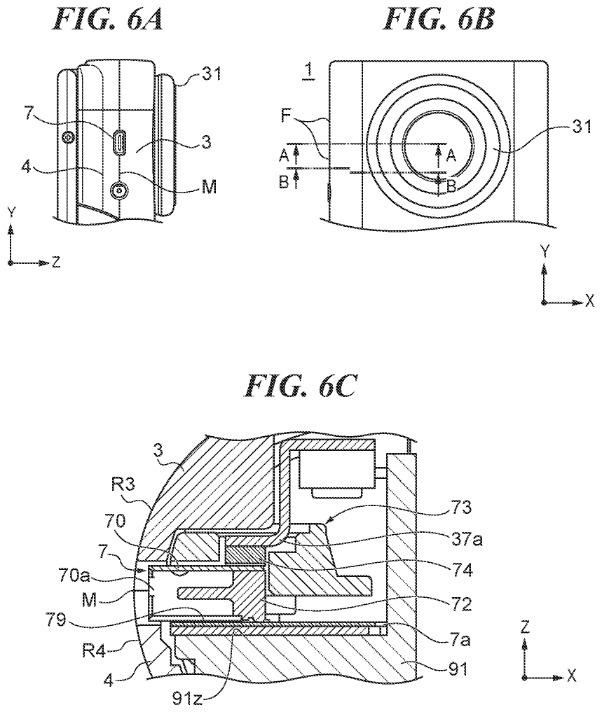

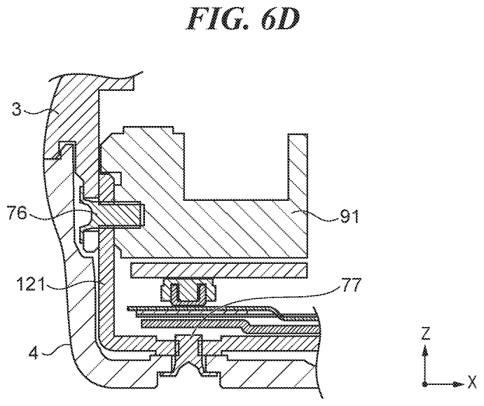

The exterior components around the HDMI connector 7 will be described with reference to FIGS. 6A to 6D. FIGS. 6A and 6B are a right-side view and a front view of the upper portion of the camera 1, respectively. FIGS. 6C and 6D are cross-sectional views taken along line A-A and line B-B in FIG. 6B, respectively.

The HDMI connector 7 is disposed at the joint position M at a side surface of a non-grip area of the camera 1 (see FIG. 6A). As described above, the HDMI connector 7 is pressed by the connection portion 37a of the front heat sink 37 arranged inside the front cover 3 via the gasket 74 and is urged toward the main base 91 (see FIG. 6C).

The gasket 74 is disposed at a location overlapping the contact connector part 72, as viewed from the Z direction. With this, the urging force applied by the gasket 74 in the −Z direction is mainly received by the contact connector part 72. Therefore, the urging force can be supported by the contact connector part 72 without largely depending on the shell 70.

Here, in conventional electronic apparatuses, from the viewpoint of good appearance and improvement of dust-proof and water-proof performance, it is general to arrange a connector cover in front of an opening of a connector. However, in the present embodiment, the connector cover is not arranged from the viewpoint of improvement of the dust-proof and water-proof performance, achieved by the connector itself, and reduction of troublesomeness for opening the connector cover when a user connects a plug.

Further, in the conventional electronic apparatuses, since the connector cover is arranged, it is general that the exterior around the opening of the connector has a flat surface. Therefore, even when a plug is pried in any direction, the flat surface can positively restrict movement of the plug.

In the present embodiment, the exterior shape around the opening 70a of the HDMI connector 7 has, as viewed from the Z direction (see FIG. 6B), a flat linear shape F where the front cover 3 and the rear cover 4 are flush with each other. On the other hand, the exterior shape has, as viewed from the Y direction (see FIG. 6C), a convex curved surface with the joint position M between the front cover 3 and the rear cover 4 as the vertex.

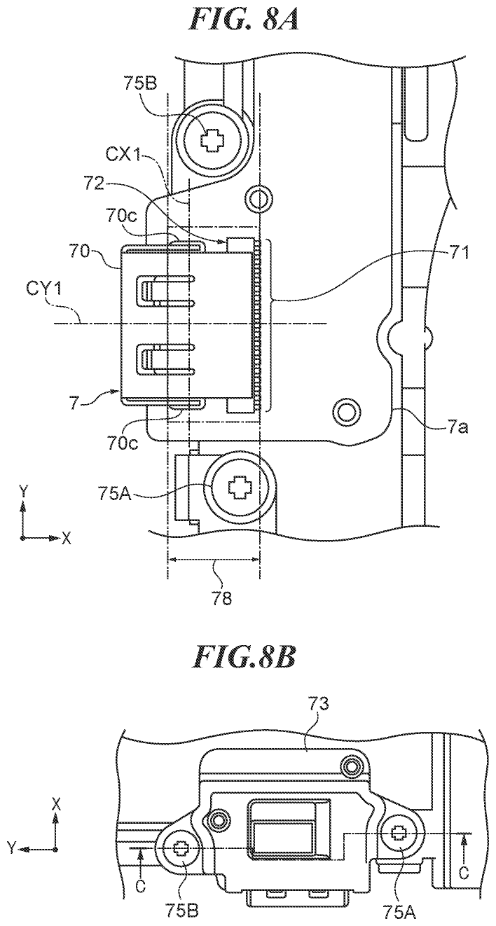

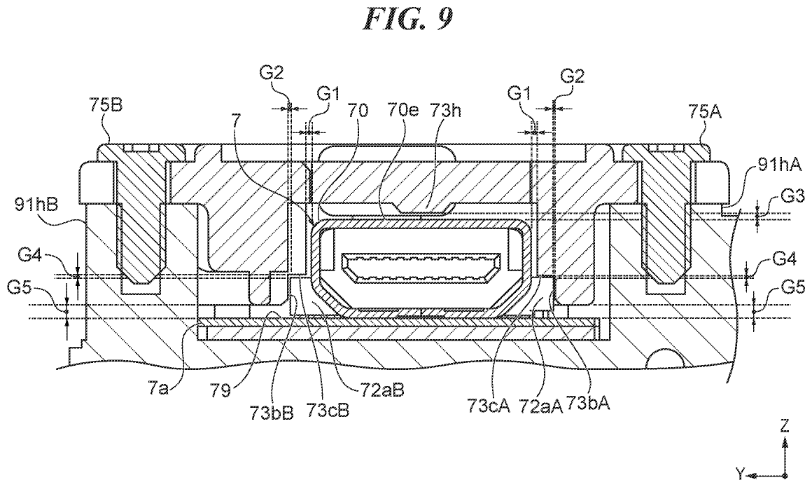

With this arrangement, when a plug is inserted into the HDMI connector 7 and pried in the Y direction, the movement of the plug can be restricted by the exterior, but when the plug is pried in the Z direction, the movement of the plug cannot be restricted by the exterior. Therefore, unless some measure is taken, when the plug is pried in the Z direction, compared with the conventional electronic apparatuses, a load is likely to be applied to the solder joint of the HDMI connector 7, and at the same time, is likely to be applied in a direction in which the front cover 3 and the rear cover 4 are opened. However, as described hereinafter with reference to FIGS. 8A to 9, these problems are solved by setting clearances.

Further, in the conventional electronic apparatuses, the screws for fixing the exterior covers in the vicinity of the connector are arranged within the connector cover and hence the screws are hidden from the appearance. However, in the present embodiment, since no connector cover is provided, if the screws are disposed in the vicinity of the HDMI connector 7, the screws are visible from the outside, which degrades the appearance.

To solve this problem, the present embodiment employs the arrangement in which the front cover 3 assembled prior to the rear cover 4 is fastened together with the main chassis 121 to the main base 91 with a screw 76, in a position hidden by the rear cover 4 (see FIG. 6D). Further, the rear cover 4 is fixed to the main chassis 121 with screws 77 in respective positions hidden by the display section 5 (see FIG. 2) (see FIGS. 6D and 2A). With this arrangement, it is possible to make the front cover 3 and the rear cover 4 difficult to be opened when the plug is pried in the Z direction, without arranging the screws in the positions visible from the outside.

When the reinforcing member 73 is assembled to the main base 91, the gasket 74 is disposed in the opening 73g formed in the shell accommodating portion 73a (see FIG. 5E). The gasket 74 is a resilient member and also a conductive member. The gasket 74 is electrically connected to the main chassis 121, which is the ground member. Therefore, the gasket 74 connects the shell 70 of the HDMI connector 7 to the main GND of the camera 1. In a state in which the reinforcing member 73 is assembled to the main base 91, the shell 70 of the HDMI connector 7 is electrically connected to the front heat sink 37 (see FIG. 3B) arranged inside the front cover 3 via the gasket 74 (see FIG. 6C). Further, the HDMI connector 7 is pressed by the connection portion 37a of the front heat sink 37 via the gasket 74 and is urged in the −Z direction. That is, the HDMI connector 7 is urged toward the mounting portion 91z (−Z side) in the direction orthogonal to the mounting surface 79 via the gasket 74.

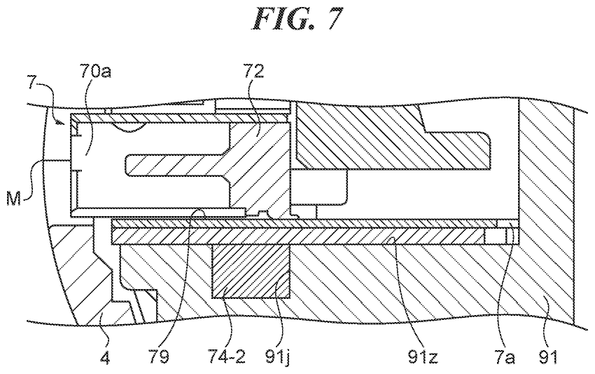

Note that as shown in a variation in FIG. 7, the main base 91 can be formed with an opening 91j on the −Z side of the HDMI connector 7, and a gasket 74-2 can be disposed in the opening 91j. The HDMI flexible circuit 7a is urged toward an opposite side (+Z side) to the mounting portion 91z in the direction orthogonal to the mounting surface 79 via the gasket 74-2. Further, an opening (not shown) for a GND signal can be formed in the −Z side surface of the HDMI flexible circuit 7a, and the GND signal can be connected to the main GND via the HDMI flexible circuit 7a.

Note that in a case where the shell 70 is not required to be connected to the main GND, an insulating cushion member (resilient member) can be arranged in place of the gasket 74 or 74-2.

The setting of clearances associated with the HDMI connector 7, the HDMI flexible circuit 7a, and the reinforcing member 73 will be described with reference to FIGS. 8A, 8B, and 9. FIG. 8A is a view of the HDMI connector 7 and the HDMI flexible circuit 7a, including the screws 75A and 75B, as viewed from the +Z side. FIG. 8B is a view of the reinforcing member 73 assembled to the HDMI connector 7, as viewed from the +Z side. FIG. 9 is a cross-sectional view taken along line C-C in FIG. 8B.

As shown in FIG. 8A, the pair of fixing portions 70c of the HDMI connector 7 are arranged in substantially the center CX1 of the whole length of the HDMI connector 7 in the plug inserting direction (X direction). To prevent damage to the solder joint of the HDMI connector 7, which is caused by a prying force applied after inserting a plug, it is effective to hold the HDMI connector 7 by the reinforcing member 73 over a length in the plug inserting direction (X direction) ranging from the −X side ends of the fixing portions 70c to the +X side ends of the plurality of contact terminals 71. For this reason, the reinforcing member 73 is fixed to the main base 91 in a position within a range 78 in the X direction. The range 78 is an area from one end position to the other end position in the X direction in the area in which the pair of fixing portions 70c and the plurality of contact terminals 71 are arranged.

The screws 75A and 75B each are arranged at least at one location on opposite sides across a center CY1 of the width of the HDMI connector 7 in the pitch direction (Y direction) of the plurality of contact terminals 71. Further, the screws 75A and 75B are arranged within the range 78 in the plug inserting direction (X direction). With these arrangements, it is possible to effectively hold the HDMI connector 7.

As shown in FIG. 9, in the pitch direction (Y direction) of the plurality of contact terminals 71, the HDMI flexible circuit 7a is not retained by the reinforcing member 73. When a plug is pried in the Y direction after being inserted, the movement of the HDMI connector 7 is restricted by the reinforcing member 73. Therefore, normally, the HDMI flexible circuit 7a is not brought into contact with the reinforcing member 73, and hence a load is difficult to be applied to the solder joint between the HDMI flexible circuit 7a and the plurality of contact terminals 71. What is more, when the plug is pried in the Y direction, the excess movement of the plug is restricted by the flat linear shape F (see FIG. 6B) of the exterior, and hence a load is more difficult to be applied to the solder joint.

Further, the minimum clearance between the reinforcing member 73 and the contact connector part 72 in the pitch direction (Y direction) of the plurality of contact terminals 71 is a clearance G2 between the flange portions 72aA and 72aB of the contact connector part 72 and the engaging portions 73bA and 73bB of the reinforcing member 73. The minimum clearance between the reinforcing member 73 and the shell 70 in the Y direction is G1. Here, the clearance G2 is smaller than the clearance G1 (G2<G1). With this, when a plug is pried in the Y direction after being inserted, a reaction force received from the reinforcing member 73 can be mainly supported not by the shell 70, but by the contact connector part 72.

The minimum clearance between the HDMI connector 7 and the reinforcing member 73 in the direction (Z direction) orthogonal to the mounting surface 79 is a clearance G4 between the flange portions 72aA and 72aB of the contact connector part 72 and the pair of contact surfaces 73cA and 73cB of the reinforcing member 73. The minimum clearance between the HDMI connector 7 and the reinforcing member 73 in the Z direction is a clearance G3 between the shell 70 and the protruding portion 73h of the reinforcing member 73. The minimum clearance between the HDMI flexible circuit 7a and the reinforcing member 73 in the Z direction is a clearance G5.

Here, the clearance G4 is smaller than the clearance G3 (G4<G3). Further, the clearance G4 is smaller than the clearance G5 (G4<G5). The clearance G5 is larger than the clearance G3 (G3<G5). That is, a magnitude relation expressed by G4<G3<G5 holds.

The HDMI connector 7 and the HDMI flexible circuit 7a move in unison within a range in which the HDMI connector 7 is restricted from moving by the reinforcing member 73. In a case where a plug is pried in the Z direction after being inserted, the movement of the plug cannot be restricted by the exterior. However, the movement of the plug is restricted by the reinforcing member 73 being brought into contact not with the HDMI flexible circuit 7a but with the HDMI connector 7, whereby load application to the solder joint is avoided.

That is, since G4<G5 holds, when the plug is pried in the Z direction, normally, the HDMI flexible circuit 7a and the reinforcing member 73 are not brought into contact with each other, but the flange portions 72a and the contact surfaces 73c are brought into contact with each other. With this, the movement of the HDMI connector 7 in the Z direction is restricted by the reinforcing member 73, and hence normally, the HDMI flexible circuit 7a is not brought into contact with the reinforcing member 73. Therefore, a load is difficult to be applied to the solder joint between the HDMI flexible circuit 7a and the plurality of contact terminals 71. This makes it possible to improve the durability of the solder joint between the HDMI connector 7 and the HDMI flexible circuit 7a.

Further, since G4<G3 holds, when the plug is pried in the Z direction, normally, the shell 70 and the reinforcing member 73 are not brought into contact with each other, but the flange portions 72a and the contact surfaces 73c are brought into contact with each other, whereby the movement of the HDMI connector 7 in the Z direction is restricted. The HDMI connector 7 is restricted from moving by the contact connector part 72, which is part including the flange portions 72a and the solder joint, being brought into contact with the reinforcing member 73, and hence the effect of preventing a load from being applied to the solder joint is high, compared with the arrangement in which the HDMI connector 7 is brought into contact with the reinforcing member 73 via the shell 70.

Further, the clearance G4 is a clearance between the flange portions 72a and the contact surfaces 73c of the reinforcing member 73, and hence the effect of preventing a load from being applied to the solder joint is high, compared with the arrangement in which the clearance G4 is a clearance between the shell 70 and the reinforcing member 73.

According to the present embodiment, the reinforcing member 73 is fixed to the main base 91, and the HDMI connector 7 and the HDMI flexible circuit 7a can move in the direction (Z direction) orthogonal to the mounting surface 79 between the main base 91 and the reinforcing member 73. In the Z direction, the minimum clearance G4 between the HDMI connector 7 and the reinforcing member 73 is smaller than the minimum clearance G5 between the HDMI flexible circuit 7a and the reinforcing member 73 (G4<G5). With this, it is possible to improve the durability of the solder joint between the HDMI connector 7 and the HDMI flexible circuit 7a.

Further, since G4<G3 holds, and the clearance G4 is a clearance between the flange portions 72a and the pair of contact surfaces 73c of the reinforcing member 73, when the plug is pried in the Z direction, it is possible to effectively prevent a load from being applied to the solder joint.

Further, since G2<G1 holds, when the plug is pried in the Y direction, a load is difficult to be applied to the solder joint.

Further, the reinforcing member 73 is fixed to the main base 91 at the opposite side positions (positions of the screw fastening portions 73e) of the HDMI connector 7 in the Y direction (see FIGS. 5C and 8A). Further, the screws 75A and 75B are arranged in the range 78 in the X direction (see FIG. 8A). With these arrangements, it is possible to effectively retain the HDMI connector 7 by the reinforcing member 73, and it is possible to effectively prevent a load from being applied to the solder joint.

Note that the present invention can be applied to a connector other than the HDMI connector 7. Further, the present invention can be applied not only to an apparatus having the image capturing function but also to any other suitable electronic apparatuses.

Note that in the present embodiment, the word “substantially” is not used to intend to exclude the meaning of “completely”. For example, the descriptions of “substantially parallel”, “substantially the same”, “substantially orthogonal”, “substantially the center”, “substantially rectangular parallelepiped”, and “substantially U-shape” include “parallel”, “the same”, “orthogonal”, “the center”, “rectangular parallelepiped”, and “U-shape”, in their complete sense.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-064316 filed Apr. 11, 2023, which is hereby incorporated by reference herein in its entirety.

What is claimed is:

1. An electronic apparatus comprising:
a circuit board having a mounting surface;
a connector mounted on the mounting surface of the circuit board, a plug being capable of being inserted into and removed from the connector;
a chassis having a mounting portion substantially parallel to the mounting surface; and
a reinforcing member that includes a portion covering the connector from an opposite side to the mounting portion in a direction orthogonal to the mounting surface and is fixed to the chassis,
wherein the connector and the circuit board can move in the direction orthogonal to the mounting surface between the chassis and the reinforcing member, and
wherein in the direction orthogonal to the mounting surface, a minimum clearance between the reinforcing member and the connector is smaller than a minimum clearance between the reinforcing member and the circuit board.

2. The electronic apparatus according to claim 1, wherein the connector includes a resin part having a plurality of contact terminals insert-molded therein, and
wherein the minimum clearance between the reinforcing member and the connector is a clearance between the reinforcing member and the resin part.

3. The electronic apparatus according to claim 2, wherein the connector further includes a shell, and
wherein the minimum clearance between the reinforcing member and the connector is smaller than a minimum clearance between the reinforcing member and the shell in the direction orthogonal to the mounting surface.

4. The electronic apparatus according to claim 1, wherein the reinforcing member is formed with an opening extending therethrough in the direction orthogonal to the mounting surface,
wherein a resilient member is disposed in the opening, and
wherein the connector is urged toward the mounting portion in the direction orthogonal to the mounting surface via the resilient member.

5. The electronic apparatus according to claim 1, wherein the mounting portion of the chassis is formed with an opening,
wherein a resilient member is disposed in the opening, and
wherein the circuit board is urged toward an opposite side to the mounting portion in the direction orthogonal to the mounting surface via the resilient member.

6. The electronic apparatus according to claim 4, wherein the resilient member is a conductive member, and is electrically connected to a ground member in the electronic apparatus.

7. The electronic apparatus according to claim 1, wherein positioning bosses are provided on the mounting portion,
wherein positioning holes are formed in the circuit board,
wherein positioning holes are formed in the reinforcing member, and
wherein the positioning bosses are inserted through the positioning holes of the circuit board and the positioning holes of the reinforcing member, whereby relative positions of the substrate and the reinforcing member to the chassis in a surface direction of the mounting surface are determined.

8. The electronic apparatus according to claim 2, wherein the reinforcing member is fixed to the chassis at opposite side positions of the connecter in a pitch direction of the plurality of contact terminals.

9. The electronic apparatus according to claim 2, wherein fixing portions for being fixed to the circuit board are extended from the connector, and
wherein the reinforcing member is fixed to the chassis at a location, between one end position to the other end position in a direction in which the plug is inserted, in an area in which the fixing portions and the plurality of contact terminals are arranged.

10. The electronic apparatus according to claim 1, wherein the connector includes a resin part having a plurality of contact terminals insert-molded therein and a shell, and
wherein in a pitch direction of the plurality of contact terminals, a minimum clearance between the reinforcing member and the resin part is smaller than a minimum clearance between the reinforcing member and the shell.

11. The electronic apparatus according to claim 1, wherein the connector is an HDMI connector.

12. The electronic apparatus according to claim 1, wherein the electronic apparatus is an image capturing apparatus having an image capturing function.
